(19) United States
(12) Patent Application Publication
(10) Pub. No.: US 2019/0064094 A1
(43) Pub. Date: Feb. 28, 2019

(54) GAS SENSOR AND GAS SENSOR PACKAGE HAVING THE SAME

(71) Applicant: POINT ENGINEERING CO., LTD., Asan (KR)

(72) Inventors: Bum Mo AHN, Suwon (KR); Seung Ho PARK, Hwaseong (KR); Sung Hyun BYUN, Hwaseong (KR)

(21) Appl. No.: 16/112,554

(22) Filed: Aug. 24, 2018

(30) Foreign Application Priority Data
Aug. 30, 2017 (KR) 10-2017-0110432

(51) Int. Cl. G01N 27/12; G01N 27/30; G01N 27/406

(52) U.S. Cl. CPC G01N 27/123; G01N 27/30; H05B 3/03; G01N 27/128; G01N 27/4067

(57) ABSTRACT

The present invention relates to a gas sensor that measures the concentration of gas through a sensing membrane and a gas sensor package having the same and, more particularly, to a gas sensor and a gas sensor package having the same that can ensure high thermal efficiency and uniform heat transfer to make it possible to be sufficiently heated with low power consumption and to precisely measure gas concentration.

### CROSS REFERENCE TO RELATED APPLICATION

The present application claims priority to Korean Patent Application No. 10-2017-0110432, filed Aug. 30, 2017, the entire contents of which is incorporated herein for all purposes by this reference.

### BACKGROUND OF THE INVENTION

### Field of the Invention

The present disclosure relates generally to a gas sensor that measures the concentration of gas through a sensing membrane, and a gas sensor package having the same.

### Description of the Related Art

A gas sensor is a sensor that measures the concentration of gas using a change in electrical characteristics caused by absorption of the gas into a sensing membrane, and a gas sensor package refers to a device having the gas sensor.

As people become more interested in the environment, the gas sensor and the gas sensor package having the same have been widely used for the purpose of the improvement of the residential space and coping with a harmful industrial environment. In recent years, the gas sensor and the gas sensor package having the same have been developed for miniaturization and high precision.

In order to make the gas sensor compact and to have high-precision, precise control for temperature of the gas sensor is required, because a change in electrical characteristics caused by absorption of the gas into the sensing membrane becomes noticeable when the sensing membrane is heated to a high temperature.

Accordingly, in order to precisely control the temperature of the gas sensor, in particular, in order to increase the thermal efficiency of the gas sensor, development has been made on a gas sensor that can be effectively heated with less power consumption through a heater electrode or the like, and such a gas sensor is disclosed in Korean Patent application No. 10-2017-0028668 (hereinafter referred to as “Patent Document 1”).

The micro sensor of the Patent Document 1 includes a substrate having a first support portion, a heater electrode formed on the first support portion, a sensor electrode formed on the first support portion, and a sensing material formed on the heater electrode and the sensor electrode.

In this case, an air gap is formed in the periphery of the first supporting portion. When the heater electrode heats the sensing material through the air gap, a thermal insulation effect is obtained by the air existing in the air gap, whereby it is possible to increase the thermal efficiency.

However, there is a problem that the micro sensor of the Patent Document 1 cannot uniformly transfer heat when the heater electrode heats the sensing material.

Explaining in detail, since the heater electrode and the sensor electrode are formed on the same plane on the first support portion, the heater electrode cannot be formed in the region where the sensor electrode is formed.

Therefore, when the heater electrode heats the sensing material, the temperature of the region where the heater electrode is formed becomes higher than the temperature of the region where the heater electrode is not formed, thereby causing a variation in temperature of the sensing material.

Such a variation in temperature of the sensing material causes a measurement error of the gas concentration, which leads to interfering with the high precision of the gas sensor.

A gas sensor package 2 according to the related art is provided such that the sensor electrode pad 7 of the gas sensor 3 is electrically connected to a wiring portion 32 and a shoulder 31 of the circuit board 30 and the shoulder 31; the sensing membrane 6 is formed on the lower surface of a substrate 4 of a gas sensor 3; and the cap 5 is provided on the circuit board 30 to protect the gas sensor 3, as shown in FIG. 13.

With the above structure, the gas sensor package 2 according to the related art has a reverse structure in which the direction into which the sensing target gas is absorbed into the sensing membrane 6 of the gas sensor 3 faces toward the upper surface of the circuit board 30.

Therefore, since the sensing membrane 6 is not positioned on the inflow path of the sensing target gas, the sensing target gas is difficult to be absorbed into the sensing membrane 6, whereby there is a problem that the accuracy of the gas concentration measurement is deteriorated.

### DOCUMENTS OF RELATED ART

(Patent Document 1) Korean Patent Application Publication No. 10-2017-0028668.

### SUMMARY OF THE INVENTION

The present invention has been conceived to solve the above-mentioned problems, and it is an object of the present invention to provide a gas sensor and a gas sensor package having the same that can ensure high thermal efficiency and uniform heat transfer to make it possible to be sufficiently heated with low power consumption and to precisely measure gas concentration.

It is another object of the present invention to provide a gas sensor and a gas sensor package having the same that can solve problems caused by a gas sensor package having a reverse structure in the related art.

A gas sensor according to an aspect of the present invention includes a substrate in which a through hole extending therethrough from an upper surface to a lower surface is formed; a sensor electrode formed above the substrate and having a sensing portion covering at least a part of the through hole; a heater electrode formed above the substrate and having a heating portion positioned above the sensing portion; and a passivation layer having an insulating portion interposed between the sensing portion and the heating portion to insulate the sensing portion and the heating portion.

In addition, the sensor electrode may include a first sensor electrode having a first sensing portion and a second sensor electrode having a second sensing portion, in which the first sensing portion surrounds at least a part of the second sensing portion and the second sensing portion surrounds at least a part of the first sensing portion.

In addition, the gas sensor may further include a filter provided below the substrate and covering the through hole.

In addition, the substrate may be made of anodized aluminum oxide (Al₂O₃), acquired by anodizing aluminum (Al) and then removing the aluminum (Al), and multiple pores may be formed in an upper surface of the substrate made of the anodized aluminum oxide.

In addition, the substrate made of anodized aluminum oxide may include a barrier layer; and a porous layer positioned above the barrier layer and provided with the multiple pores.

In addition, the gas sensor may further include a sensing membrane formed below the sensing portion.

According to an aspect of the present invention, there is disclosed a gas sensor package having a circuit board and a gas sensor electrically connected to the circuit board, the gas sensor including: a substrate in which a through hole extending therethrough from an upper surface to a lower surface is formed; a sensor electrode formed above the substrate and having a sensing portion covering at least a part of the through hole; a heater electrode formed above the substrate and having a heating portion positioned above the sensing portion; a passivation layer having an insulating portion interposed between the sensing portion and the heating portion to insulate the sensing portion and the heating portion; and a sensing membrane formed below the sensing portion, in which the gas sensor is installed upside down on an upper surface of the circuit board so that a direction in which the sensing membrane, the sensor electrode, the passivation layer, and the heater electrode are laminated sequentially is the same as a direction in which a lower surface of the circuit board faces.

In addition, the substrate may be made of anodized aluminum oxide, acquired by anodizing aluminum and then removing the aluminum, the substrate made of anodized aluminum oxide may include a barrier layer and a porous layer positioned above the barrier layer and provided with multiple pores, and a direction in which the multiple pores are open is the same as a direction in which a lower surface of the circuit board faces.

According to the gas sensor and the gas sensor package having the same of the present invention as described above, the following effects can be obtained.

Unlike the gas sensor package in the related art, since a sensing membrane is formed in the inflow direction of the sensing target gas, the gas can be easily absorbed into the sensing membrane.

The gas sensor can be easily protected only by a filter without a separate protection portion.

Since the pores of the substrate are open in the direction opposite to the direction in which the sensing target gas flows, it is possible to prevent the substrate from being contaminated by the gas.

Since the sensing portion of the sensor electrode and the heating portion of the heater electrode are not positioned on the same plane, the heating portion can uniformly transfer heat to the entire sensing portion. Therefore, the heat can be uniformly transferred to the sensing membrane.

Also, the heat can be uniformly transferred to the sensing membrane by the insulating portion of the passivation layer.

Since the sensing membrane is positioned inside the through-hole, it is possible to obtain thermal insulation effect. Accordingly, the temperature of the sensing membrane can be easily maintained, and thus the temperature of the sensing membrane can be increased even with small power consumption, thereby achieving compact gas sensor.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view of a gas sensor according to a preferred embodiment of the present invention;

FIG. 2 is an exploded perspective view of the gas sensor of FIG. 1;

FIG. 3 is a plan view of the gas sensor of FIG. 1;

FIG. 4 is a bottom view of the gas sensor of FIG. 1;

FIG. 5 is a cross-sectional view taken along a line A-A′ of FIG. 3;

FIG. 6 is a plan view showing a state in which the first and second sensor electrodes of the gas sensor of FIG. 1 are separated from each other;

FIG. 7 is a plan view showing that the first and second sensing portions of the first and second sensor electrodes of FIG. 6 are coupled in such a manner as to surround each other to form a sensing portion;

FIG. 8 is an enlarged view of the sensing portion of FIG. 7;

FIG. 9 is a plan view of the heater electrode of FIG. 1;

FIG. 10 is an enlarged view of the heating portion of FIG. 9;

FIG. 11 is a top view of the passivation layer of FIG. 1;

FIG. 12 is a cross-sectional view of a gas sensor package having the gas sensor of FIG. 1 according to a preferred embodiment of the present invention; and

FIG. 13 is a cross-sectional view of a gas sensor package in the related art.

### DETAILED DESCRIPTION OF THE INVENTION

Hereinafter, preferred embodiments of the present invention will be described with reference to the accompanying drawings.

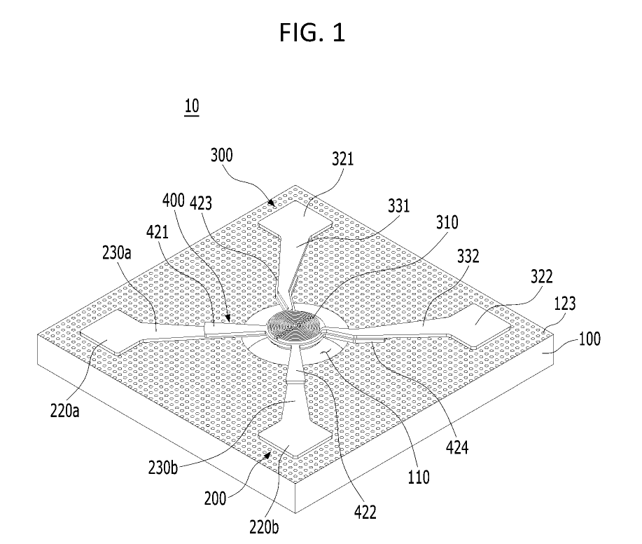

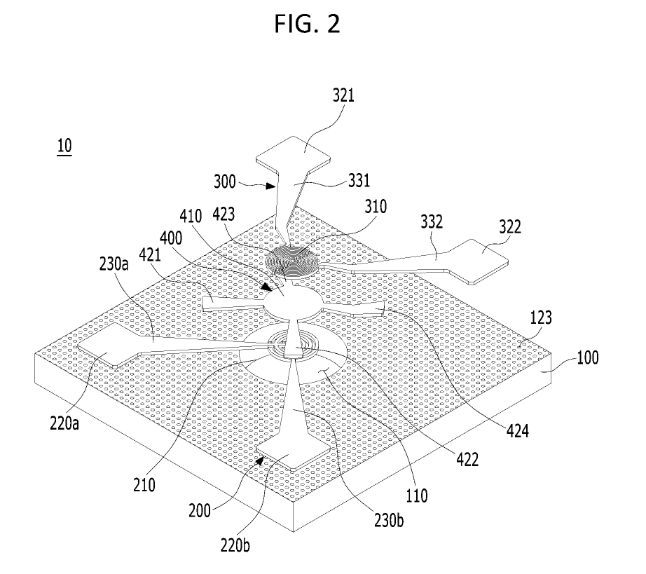

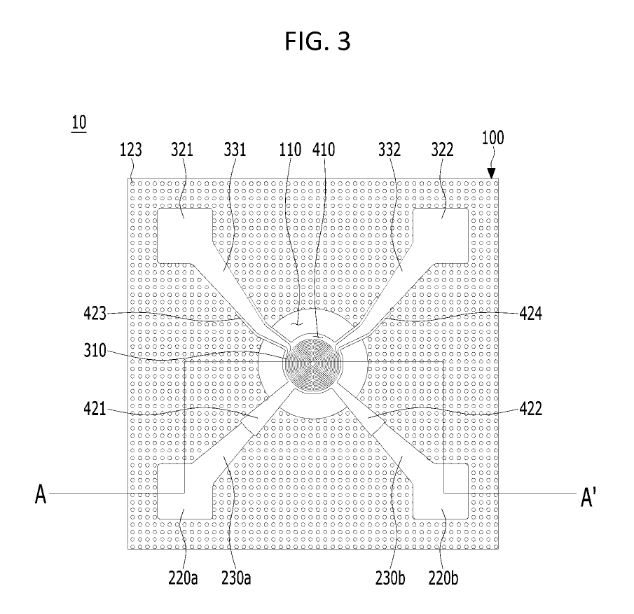

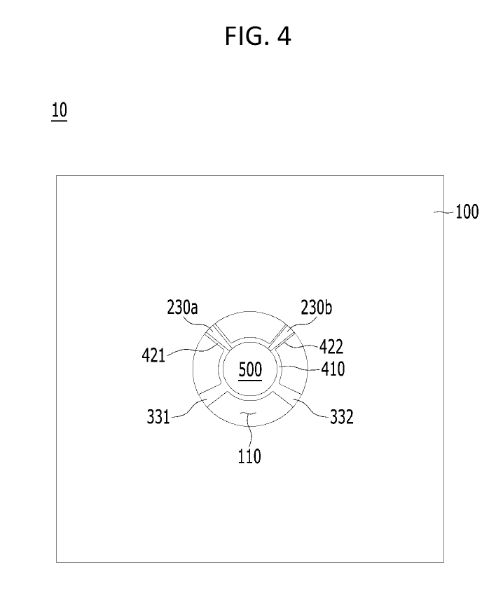

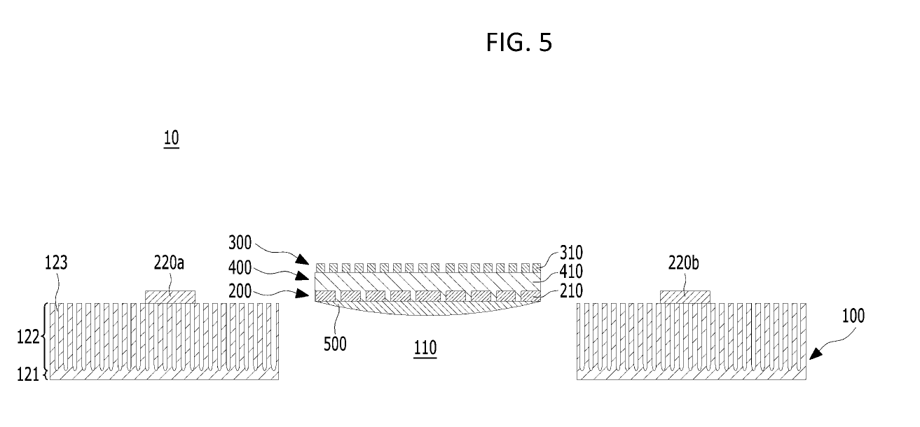

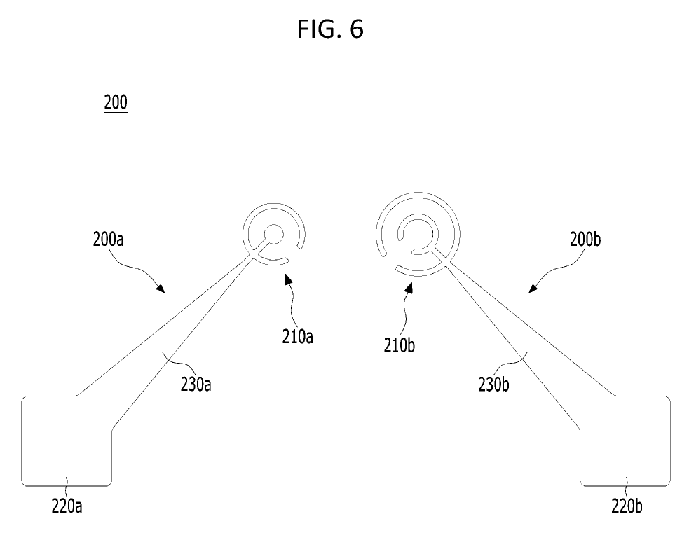

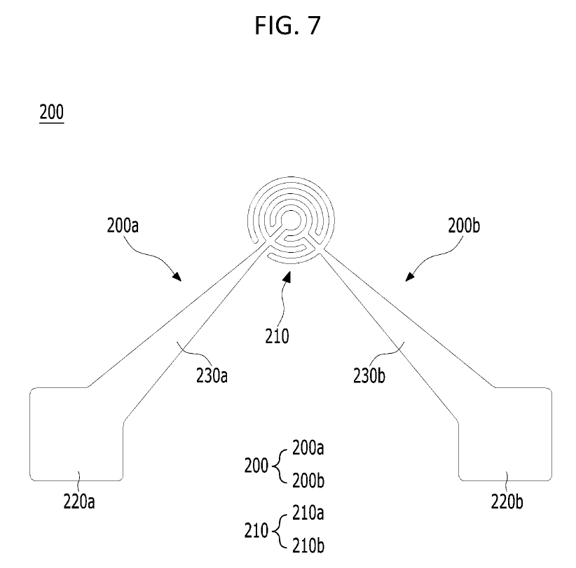

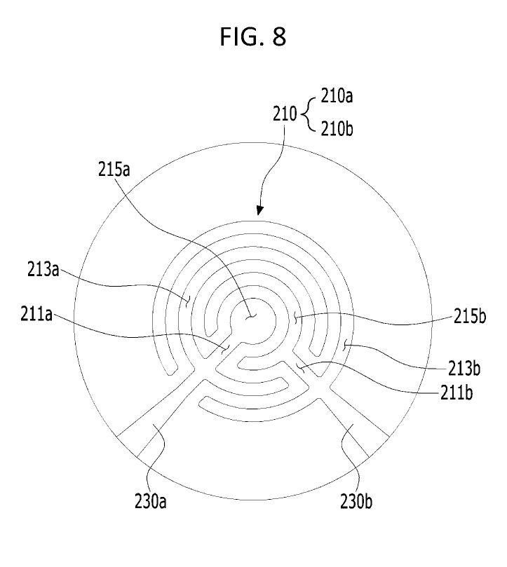

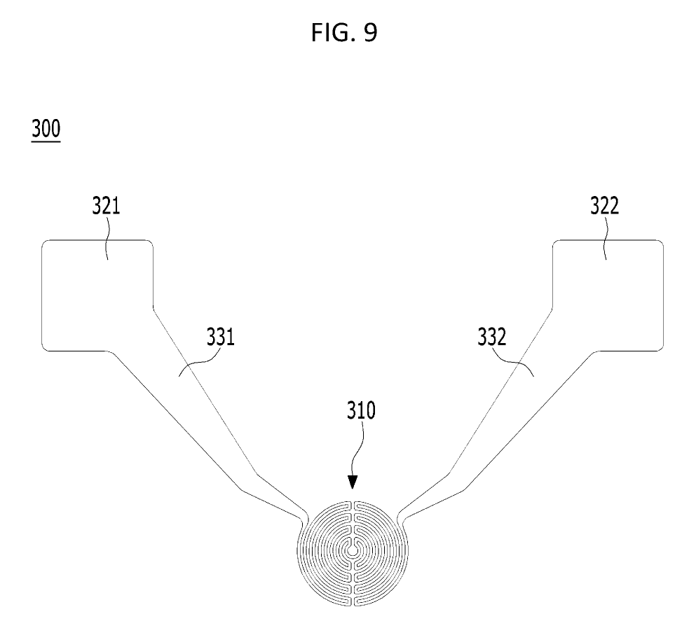

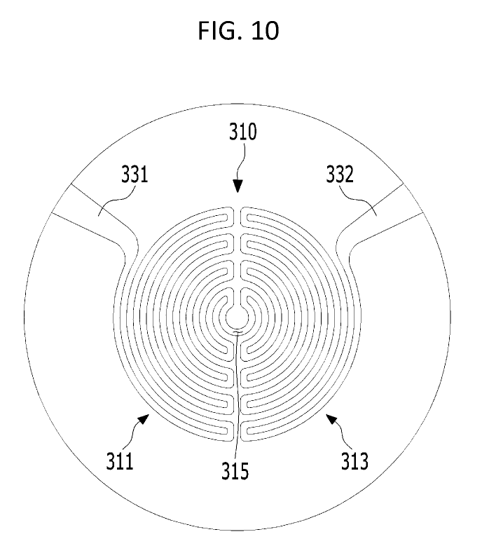

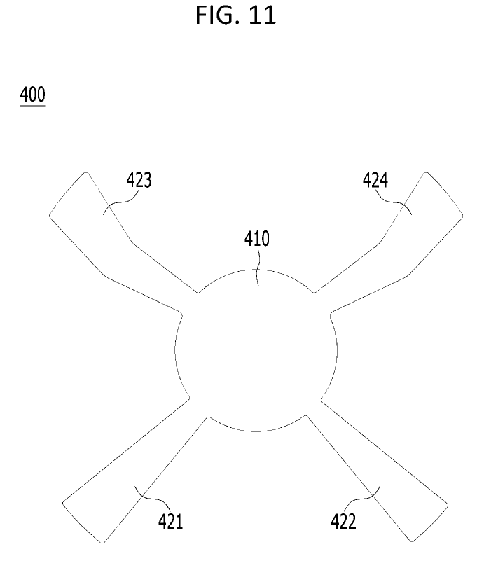

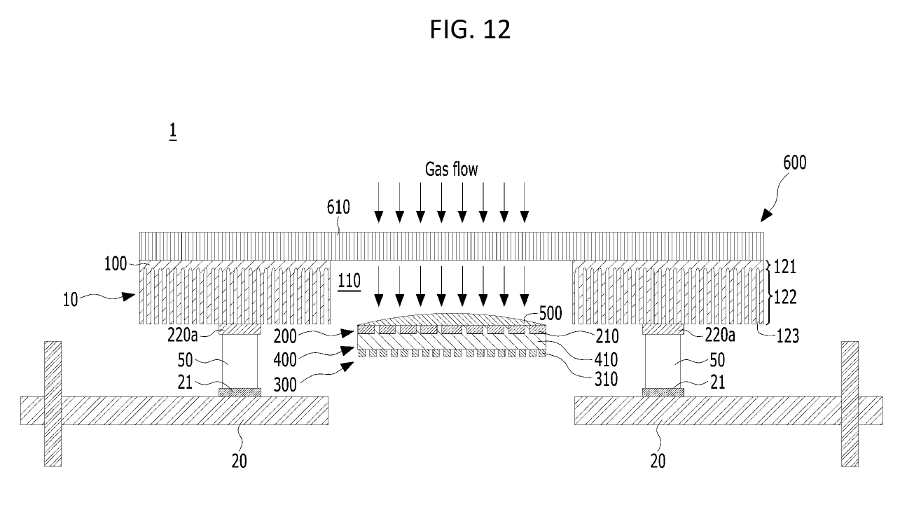

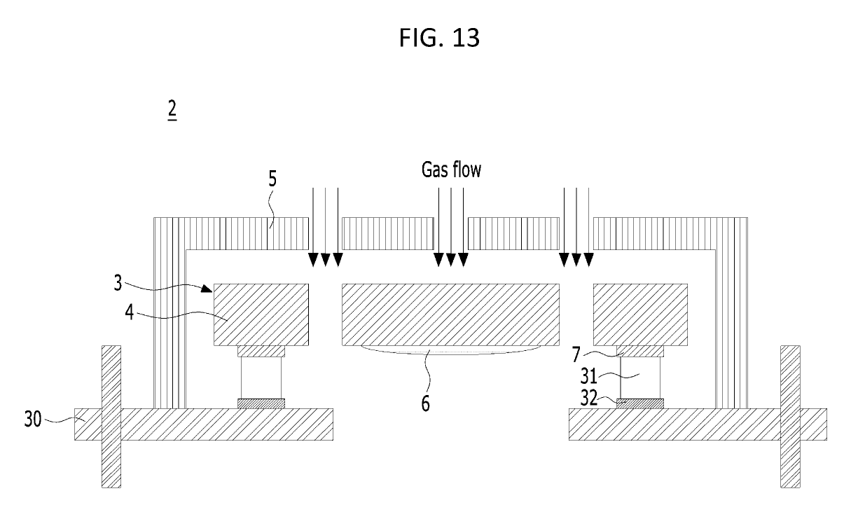

FIG. 1 is a perspective view of a gas sensor according to a preferred embodiment of the present invention, FIG. 2 is an exploded perspective view of the gas sensor of FIG. 1, FIG. 3 is a plan view of the gas sensor of FIG. 1, FIG. 4 is a bottom view of the gas sensor of FIG. 1, FIG. 5 is a cross-sectional view taken along a line A-A′ of FIG. 3, FIG. 6 is a plan view showing a state in which the first and second sensor electrodes of the gas sensor of FIG. 1 are separated from each other, FIG. 7 is a plan view showing that the first and second sensing portions of the first and second sensor electrodes of FIG. 6 are coupled in such a manner as to surround each other to form a sensing portion, FIG. 8 is an enlarged view of the sensing portion of FIG. 7, FIG. 9 is a plan view of the heater electrode of FIG. 1, FIG. 10 is an enlarged view of the heating portion of FIG. 9, FIG. 11 is a top view of the passivation layer of FIG. 1, FIG. 12 is a cross-sectional view of a gas sensor package having the gas sensor of FIG. 1 according to a preferred embodiment of the present invention, and FIG. 13 is a cross-sectional view of a gas sensor package in the related art.

A Gas Sensor 10 According to a Preferred Embodiment of the Present Invention

Hereinafter, a gas sensor 10 according to a preferred embodiment of the present invention will be described.

As shown in FIGS. 1 to 5, a gas sensor 10 according to a preferred embodiment of the present invention includes a substrate 100 in which a through hole 110 extending therethrough from an upper surface to a lower surface is formed, a filter 600 provided below the substrate 100 and covering the through hole 110, a sensor electrode 200 provided above the substrate 100 and having a sensing portion 210 covering at least a part of the through hole 110, a heater electrode 300 formed above the substrate 100 and having a heating portion 310 positioned above the sensing portion 210, a passivation layer 400 having an insulating portion 410 interposed between the sensing portion 210 and the heating portion 310 to insulate the sensing portion 210 and the heating portion 310, and a sensing membrane 500 formed below the sensing portion 210.

Hereinafter, the substrate 100 will be described.

The substrate 100 is provided with the through hole 110 extending therethrough from the upper surface to the lower surface. The sensor electrode 200 and the heater electrode 300 are formed above the substrate 100, i.e., on an upper surface of the substrate 100, and a filter 600 is formed below the substrate 100, i.e., on a lower surface of the substrate 100.

The through hole 110 is formed to extend through the substrate 100 from the upper surface to the lower surface at the center of the substrate 100 and is formed larger than the sensing portion 210, the heating portion 310 and the insulating portion 410.

Accordingly, the sensing portion 210 covers the top of a part of the through hole 110, not the entire through hole 110, as shown in FIGS. 1 to 4.

The substrate 100 may be made of anodized aluminum oxide (Al₂O₃), which is acquired by anodizing aluminum (Al) and then removing the aluminum (Al).

In this case, a plurality of pores 123 may be formed on the upper surface of the substrate 100 made of anodized aluminum oxide (Al₂O₃).

More specifically, as shown in FIG. 5, the substrate 100 made of anodized aluminum oxide (Al₂O₃) is configured to include a barrier layer 121 and a porous layer 122 that is positioned above the barrier layer 121 and having multiple pores 123 formed therein.

Accordingly, the multiple pores 123 are such that the lower part thereof is blocked by the barrier layer 121, and therefore the multiple pores 123 are provided to open only the upper surface of the substrate 100.

The multiple pores 123 have air existing therein. Therefore, the thermal insulation effect of the substrate 100 itself increases due to the thermal insulating effect of the air, and thus the thermal efficiency of the gas sensor 10 increases.

Therefore, when heating the sensing membrane 500 through the heater electrode 300, the heat insulation is sufficiently obtained, whereby there is an advantage that the thermal efficiency of the gas sensor 10 increases.

Hereinafter, the filter 600 will be described.

The filter 600 may filter foreign matter through the filter pores 610 when sensing target gas flows in, thereby achieving high precision gas concentration measurement for the sensing target gas.

In addition, it is preferable that the filter 600 is subjected to a hydrophobic treatment, thereby preventing water from being permeated. As described above, since the water is prevented from being permeated by the filter 600, gas concentration measurement may be more precisely achieved.

In addition, since the filter 600 is provided below the substrate 100 to cover the through hole 110, it is possible to protect the sensing membrane 500 positioned inside the through hole 110.

The detailed description of the filter 600 will be described later in the description of a gas sensor package 1 according to a preferred embodiment of the present invention.

Although the filter 600 is positioned at the uppermost portion of the gas sensor package 1 in FIG. 12, it will be appreciated that the filter 600 is provided below the substrate 100 because the gas sensor 10 is installed upside down on the circuit board 20, which will be described later.

Hereinafter, the sensor electrode 200 will be described.

The sensor electrode 200 is formed above the substrate 100 and the sensing portion 210 provided in the sensor electrode 200 covers at least a part of the upper portion of the through hole 110.

The sensing portion 210 is formed with the first and second sensing portions 210, which will be described later, and a sensing membrane 500 is formed on the lower part of the sensing portion 210, i.e., below the sensing portion 210.

The sensor electrode 200 is electrically connected to the sensing membrane 500 and the circuit board 20 and transmits electrical characteristics of the gas measured by the sensing membrane 500 to the circuit board 20.

As shown in FIG. 6, the sensor electrode 200 includes a first sensor electrode 200a having a first sensing portion 210a and a second sensor electrode 200b having a second sensing portion 210b.

In this case, as shown in FIGS. 7 and 8, the first sensing portion 210a surrounds at least a part of the second sensing portion 210b, the second sensing portion 210b surrounds at least a part of the first sensing portion 210a, in which the first sensing portion 210a and the second sensing portion 210b are separated apart so as not to contact each other and are positioned on the same plane.

The first sensing portion 210a and the second sensing portion 210b form the sensing portion 210 of the sensor electrode 200.

Hereinafter, the first sensor electrode 200a and the second sensor electrode 200b will be described in detail.

As shown in FIGS. 6 and 7, the first sensor electrode 200a is formed on the upper surface of the substrate 100 and is configured to include a first sensing portion 210a covering at least a part of the upper portion of the through hole 110, a first sensor electrode pad 220a formed on the upper surface of the substrate 100, and a first sensor electrode bridge 230a connecting the first sensing portion 210a and the first sensor electrode pad 220a.

The first sensing portion 210a forms the sensing portion 210 together with the second sensing portion 210b. Accordingly, the first sensing portion 210a has a sensing membrane 500 formed on the lower surface thereof, whereby it is possible to transmit the electrical signal transmitted from the sensing membrane 500 to the circuit board 20 and support the sensing membrane 500 in such a manner as to be positioned in the upper portion of the through hole 110.

The first sensor electrode pad 220a is formed on the front left side from the top surface of the substrate 100 and connects the circuit board 20 and the gas sensor 10, thereby electrically connecting the gas sensor 10 and the circuit board 20.

The first sensor electrode bridge 230a connects the first sensing portion 210a and the first sensor electrode pad 220a to support the first sensing portion 210a so that the first sensing portion 210a may be positioned in the upper portion of the through hole 110.

As shown in FIGS. 6 and 7, the second sensor electrode 200b is formed on the upper surface of the substrate 100 and is configured to include a second sensing portion 210b covering at least a part of the upper portion of the through hole 110, a second sensor electrode pad 220b formed on the upper surface of the substrate 100, a second sensing portion 210b, and a second sensor electrode bridge 230b connecting the second sensor electrode bridge 220b.

The second sensor electrode pad 220b is formed on the front right side from the upper surface of the substrate 100 and connects the circuit board 20 and the gas sensor 10, thereby electrically connecting the gas sensor 10 and the circuit board 20.

The second sensor electrode bridge 230b connects the second sensing portion 210b and the second sensor electrode pad 220b to support the second sensing portion 210b so that the second sensing portion 210b may be positioned in the upper portion of the through hole 110.

Hereinafter, the first sensing portion 210a and the second sensing portion 210b will be described in detail.

As shown in FIG. 8, the first sensing portion 210a is configured to include a first rectilinear portion 211a extending from the first sensor electrode bridge 230a, a second arc portion 213a extending from the first rectilinear portion 211a and having an arc shape, and a circular portion 215a positioned inside the second arc portion 213a.

In addition, the second sensing portion 210b includes a second rectilinear portion 211b extending from the second sensor electrode bridge 230b, a first arc portion 213b extending from the second rectilinear portion 211b, and a third arc part 215b positioned inside the first arc portion 213b.

Accordingly, the sensing portion 210 may be configured such that the first sensing portion 210a may surround at least a part of the second sensing portion 210b and the second sensing portion 210b may surround at least a part of the first sensing portion 210a.

In other words, the first and second sensing portions 210a and 210b may surround each other in such a manner that the first arc portion 213b of the second sensing portion 210b surrounds the second arc portion 213a of the first sensing portion 210a, the second arc portion 213a of the first sensing portion 210a surrounds the third arc portion 215b of the second sensing portion 210b, and the third arc portion 215b surrounds the circular portion 215a of the first sensing portion 210a.

More specifically, the first to third arc portions 213b, 213a, and 215b and the circular portion 215a are structured to surround each other in an alternating way, whereby the sensing portion 210 including the first and second sensing portions 210a and 210b is structured on the same plane, in such a manner that the second arc portion 213a is positioned inside the first arc portion 213b, the third arc portion 215b is positioned inside the second arc portion 213a, the circular portion 215a is positioned inside the third arc portion 215b, and the first sensing portion 210a and the second sensing portion 210b are spaced apart from each other so as not to be in contact with each other.

The sensor electrode 200 described above, that is, the first and second sensor electrodes 200a and 200b may be formed of a metal mixture material containing one or at least one of metal materials such as platinum (Pt), tungsten (W), cobalt (Co), nickel (Ni), silver (Au), copper (CU), and the like.

Hereinafter, the heater electrode 300 will be described.

The heater electrode 300 is formed above the substrate 100, and the heating portion 310 provided in the heater electrode 300 is positioned above the sensing portion 210. The heater electrode 300 functions to control the temperature by heating the sensing portion 210 and the sensing membrane 500 through the heating portion 310.

In addition, as shown in FIG. 9, the heater electrode 300 is configured to include a heating portion 310 disposed above the sensing portion 210 to heat the sensing membrane 500, first and second heater electrode pads 321 and 322 formed on the upper surface of the substrate 100, and first and second heater electrode bridges 331 and 332 connecting the heating portion 310 and the first and second heater electrode pads 321 and 322, respectively.

The heating portion 310 is formed on the upper surface of the insulating portion 410 of the passivation layer 400, and thus positioned above the sensing portion 210.

Accordingly, when the heater electrode 300 is operated to allow the heating portion 310 to be heated, the insulating portion 410 positioned below the heating portion 310, and the sensing portion 210 positioned below the insulating portion 410, and the sensing membrane 500 positioned below the sensing portion 210 are heated.

In other words, the heating portion 310 functions to heat the insulating portion 410, the sensing portion 210, and the sensing membrane 500.

The heating portion 310 is configured to include a first multiple arcs portion 311 having multiple arcs by causing the heating wire extending from the first heater electrode bridge 331 to have multiple arcs and a rectilinear portion in a direction opposite to the first heater electrode bridge 331 (i.e., in the direction of the connecting portion 315), a second multiple arcs portion 313 having multiple arcs by causing the heating wire extending from the second heater electrode bridge 332 to have multiple arcs and rectilinear portion in a direction opposite to the second heater electrode bridge 332 (i.e., in the direction of the connecting portion 315), and a connecting portion 315 connecting the first multiple arcs portion 311 and the second multiple arcs portion 313 at the center of the heating portion 310.

Thus, the heating portion 310 has a shape with multiple arcs inwards in both sides (in the direction of the connection portion 315), by the first and second multiple arcs portions 311 and 313 extending from the first heater electrode bridge 331 and the second heater electrode bridge 332, respectively.

The first and second heater electrode pads 321 and 322 are formed on the upper surface of the substrate 100 and are electrically connected to a wiring portion 21 of the circuit board 20.

The first and the second heater electrode bridges 331 and 332 function to connect the first and the second heater electrode pads 321 and 322 to the heating portion 310.

Accordingly, when electricity is applied to the first and the second heater electrode pads 321 and 322, the electricity is transferred to the heating portion 310 through the first and the second heater electrode bridges 331 and 332. The electricity energy is converted into thermal energy by resistance of the heating wire of the heating portion 310, so that the heating portion 310 may be heated.

Also, since the heating portion 310 is supported by the first and second heater electrode bridges 331 and 332, the heating portion 310 may be easily positioned in the upper portion of the through hole 110. Of course, in this case, since the heating portion 310 is positioned above the passivation layer 400 formed above the sensing portion 210, the heating portion 310 is supported by the sensing portion 210 and the passivation layer 400.

The heater electrode 300 may be formed of a metal mixture material containing one or at least one of metal materials such as platinum (Pt), tungsten (W), cobalt (Co), nickel (Ni), silver (Au), copper (Cu), and the like.

Hereinafter, the passivation layer 400 will be described.

The insulating portion 410 provided in the passivation layer 400 is interposed between the heating portion 310 of the sensing electrode 210 and the heating portion 310 of the heater electrode 300 and functions to insulate the sensing portion 210 and the heating portion 310 and evenly transfer heat generated in the heating portion 310 to the sensing portion 210.

Further, as shown in FIG. 11, the passivation layer 400 is configured to include the insulating portion 410 interposed between the sensing portion 210 and the heating portion 310, first and second supporting portions 421 and 422 each of which is connected to the insulating portion 410 and formed above the first and second sensor electrode bridges 230a and 230b, and third and fourth support portions 423 and 424 of which is connected to the insulating portion 410 and formed in such a manner as to be interposed between the first and second heater electrode bridge 331 and 332 and the substrate 100.

The passivation layer 400 is provided such that the insulating portion 410 is positioned to be interposed between the sensing portion 210 and the heating portion 310, and the first and second supporting portions 421 and 422 are positioned above the first and second sensor electrode bridges 230a and 230b, and third and fourth support portions 423 and 424 are positioned to be interposed between the first and second heater electrode bridges 331 and 332 and the substrate 100, respectively.

Accordingly, the first to fourth supporting portions 421, 422, 423, and 424 function to reinforce the supporting force of the first and second sensor electrode bridges 230a and 230b and the first and second heater electrode bridges 331 and 332.

The above-described passivation layer 400 may be formed of an oxide-based material.

Furthermore, the passivation layer 400 may be formed of at least one of tantalum oxide (TaOₓ), titanium oxide (TiO₂) , silicon oxide (SiO₂), and aluminum oxide (Al₂O₃).

Hereinafter, the sensing membrane 500 will be described.

The sensing membrane 500 is formed on the lower surface of the sensing portion 210, that is, below the sensing portion 210, and functions to sense the concentration of the gas due to change in electric characteristic caused by absorbing the sensing target gas.

As described above, the sensing membrane 500 is formed below the sensing portion 210, and therefore, is positioned inside the through hole 110.

A method of Manufacturing a Gas Sensor 10 According to a Preferred Embodiment of the Present Invention

Hereinafter, a method of manufacturing the gas sensor 10 according to a preferred embodiment of the present invention will be described.

First, the sensor electrode 200 is formed on the upper surface of the substrate 100. In this case, the upper surface of the substrate 100 is masked except for an area where the sensor electrode 200 is to be formed, and then sensor electrode 200 is formed using a metal material or metal mixture material described above.

After the sensor electrode 200 is formed, the upper surface of the substrate 100 and the upper surface of the sensor electrode 200 are masked except for an area where the passivation layer 400 is to be formed, and then the passivation layer 400 is formed using the oxide-based material or oxide material described above.

After the passivation layer 400 is formed, the upper surface of the substrate 100, the upper surface of the sensor electrode 200, and the upper surface of the passivation layer 400 are masked except for an area where the heater electrode 300 is to be formed, and then the heater electrode 300 is formed using the metal mixture material or metal mixture material described above.

After the heater electrode 300 is formed, the substrate 100 is masked except for an area at the center of the substrate 100 where the through hole 110 is formed, and then the through hole 110 is formed through etching.

In this case, when the substrate 100 is made of anodized aluminum oxide (Al₂O₃), the through hole 110 may be easily formed without damaging the sensor electrode 200, the passivation layer 400, and the heater electrode 300, by using an etchant that reacts with anodized aluminum oxide (Al₂O₃).

As the through hole 110 is formed as described above, the lower surface of the sensing portion 210 of the sensor electrode 200 is exposed.

After the through hole 110 is formed, the substrate 100 is masked except for an area where the sensing membrane 500 is to be formed, that is, the exposed lower surface of the sensing portion 210, and then the sensing membrane 500 is formed, whereby production of the gas sensor 10 is completed.

As described above, the gas sensor 10 is provided such that the substrate 100, the sensor electrode 200, the passivation layer 400, the heater electrode 300, the through hole 110, and the sensing membrane 500 are formed sequentially.

In other words, the sensor electrode 200, the passivation layer 400, and the heater electrode 300 are formed in such a manner to be laminated on the upper surface of the substrate 100 in the order of the sensor electrode 200, the passivation layer 400, and the heater electrode 300, the through hole 110 is formed at the center of the substrate 100, and then the sensing membrane 500 is formed on the lower surface of the sensing portion 210 of the sensor electrode exposed by the through hole 110, whereby production of the gas sensor 10 is completed.

In this case, each of components at the front area of the substrate 100 on which the sensor electrode 200 is formed, the rear area of the substrate 100 on which the heater electrode 300 is formed, and an area where the through hole 110 is positioned, i.e., the center area of the substrate 100 has a difference in the laminating order thereof.

In the front area of the substrate 100 on which the sensor electrode 200 is formed, the first and second sensor electrode bridges 230a and 230b of the first and second sensor electrodes 200 are formed on the upper surface of the substrate 100, and the first and second support portions 421 and 422 of the passivation layer 400 are formed on the upper surfaces of the first and second sensor electrode bridges 230a and 230b, respectively.

In other words, the front area of the substrate 100 is such that the substrate 100, the first and second sensor electrode bridges 230a and 230b of the first and second sensor electrodes 200 of the sensor electrode 200, and the first and the second supporting portions 421 and 422 of the passivation layer 400 are laminated sequentially from bottom to top direction.

In the rear area of the substrate 100 on which the heater electrode 300 is formed, the third and fourth supporting portions 423 and 424 of the passivation layer 400 are formed on the upper surface of the substrate 100, and the first and second heater electrode bridges 331 and 332 of the heater electrode 300 are formed on each of the upper surfaces of the third and fourth supporting portion 423 and 424.

In other words, the rear area of the substrate 100 is such that the substrate 100, the third and fourth supports 423 and 424 of the passivation layer 400, the first and second heater electrode bridges 331 and 332 of the heater electrode 300 are laminated sequentially from bottom to top direction.

In the area where the through hole 110 is positioned, that is, the central area of the substrate 100, the sensing portion 210 of the sensor electrode 200 is positioned in the upper portion of the through hole 110, and the insulating portion 410 of the passivation layer 400 is formed on the upper surface of the sensing portion 210, a heating portion 310 of the heater electrode 300 is formed on the upper surface of the insulating portion 410, and the sensing membrane 500 is formed on the lower surface of the sensing portion 210.

In other words, the central area of the substrate 100 is such that the sensing membrane 500, sensing portion 210 of the sensor electrode 200, the insulating portion 410 of the passivation layer 400, the heating portion 310 of the heater electrode 300 are laminated sequentially from bottom to top direction.

In this case, the sensing portion 210 is supported by the first and second sensor electrode bridges 230a and 230b, thereby making the sensing portion 210 floating in the upper area of the through hole 110. Accordingly, the sensing portion 210, the insulating portion 410, and the heating portion 310 are positioned in the upper area of the through hole 110, and the sensing membrane 500 is positioned inside the through hole 110.

A Gas Sensor Package 1 According to a Preferred Embodiment of the Present Invention

Hereinafter, a gas sensor package 1 having the gas sensor 10 according to a preferred embodiment of the present invention will be described.

The gas sensor package 1 means a package in which the gas sensor 10 according to the preferred embodiment of the present invention is installed upside down on the circuit board 20. As shown in FIG. 12, the gas sensor package 1 according to a preferred embodiment of the present invention is configured to include the circuit board 20 and the gas sensor 10 electrically connected to the circuit board 20.

In this case, since the gas sensor 10 has been described above, redundant description is omitted.

The circuit board 20 is positioned below the gas sensor package 1 to function to support the gas sensor 10 and is electrically connected to the sensor electrode 200 and the heater electrode 300 of the gas sensor 10.

A wiring portion 21 provided on the circuit board 20 is electrically connected to the sensor electrode 200 or the heater electrode 300 to cause electrical characteristics of the sensing membrane 500 transferred from the sensor electrode 200 to be measured and applies electricity to the heater electrode 300 to cause the heating portion 310 of the heater electrode 300 to be operated.

The circuit board 20 may be made of a PCB or the like, and the wiring portion 21 and the sensor electrode 200 or the heater electrode 300 are electrically connected to each other by a shoulder 50.

The gas sensor 10 is installed upside down on the upper surface of the circuit board so that a direction in which the sensing membrane 500, the sensor electrode 200, the passivation layer 400, and the heater electrode 300 are laminated sequentially is the same as the direction in which the lower surface of the circuit board 20 faces.

Therefore, the direction in which the lower surface of the sensing membrane 500 faces is the same as the upward direction in FIG. 12.

Also, as described above, the filter 600 is provided on the lower surface of the substrate 100.

In this case, the direction in which the lower surface of the filter 600 faces is the same as the upward direction in FIG. 12.

In addition, the filter 600 may be made of anodized aluminum oxide (Al₂O₃), which is acquired by anodizing aluminum (Al) and then removing the aluminum (Al).

In this case, the filter 600 made of anodized aluminum oxide (Al₂O₃) may be provided with filter pores 610 extending from the top to the bottom.

Accordingly, the sensing target gas flows in through the filter pores 610 of the filter 600 so that the sensing target gas may be easily absorbed into the sensing membrane 500, whereby the sensing membrane 500 may detect the concentration of the sensing target gas.

In other words, since the filter pores 610 of the filter 600 functions as a gas inlet through which the sensing target gas flows, the sensing target gas may be easily absorbed into the sensing membrane 500.

In addition, as described above, the filter is given a hydrophobic surface treatment to prevent moisture from flowing into the gas sensor 10, thereby increasing the accuracy of gas concentration measurement performed by the gas sensor 10.

Hereinafter, the operation of measuring the sensing target gas using the gas sensor 10 and the gas sensor package 1 having the same according to the preferred embodiment of the present invention will be described.

First, the heater electrode 300 electrically connected to the wiring portion 21 of the circuit board 20 is operated to cause the electrical energy to be converted into thermal energy, whereby the heating portion 310 of the heater electrode 300 heats the sensing membrane 500.

In this case, the temperature of the sensing membrane 500 is heated to the temperature that is most suitable for measuring the concentration of the sensing target gas.

The sensing target gas flows in through the filter pores 610 of the filter 600, flows into the through hole 110, and then is absorbed into the sensing membrane 500, as shown in FIG. 12.

When the sensing target gas is absorbed into the sensing membrane 500, the sensing membrane 500 undergoes a change in electrical characteristics. Such electrical signal is transferred to a computing portion (not shown) through the first and second sensing portions 210a and 210b, the first and second sensor electrode bridge 230a and 230b, the first and second sensor electrode pads 220a and 220b, the shoulder 50, and the wiring portion 21.

Accordingly, the computing portion computes the concentration of the sensing target gas by computing the changed electrical characteristics of the sensing membrane 500.

Effects of the Gas Sensor 10 and the Gas Sensor Package 1

The gas sensor 10 and the gas sensor package 1 as described above have the following effects.

First, the effect of the gas sensor package 1 having the above-described configuration according to the preferred embodiment of the present invention will be described.

The gas sensor package in the related art has a reverse structure that the direction in which the sensing target gas is absorbed into the sensing membrane of the gas sensor faces the upper surface of the circuit board. Therefore, the portion in which the gas flows differs from the position where the sensing membrane is formed, whereby a separate protection portion for protecting the gas sensor is required.

Meanwhile, the gas sensor package 1 according to the preferred embodiment of the present invention has a structure that the direction in which the sensing target gas is absorbed into the sensing membrane 500 faces the filter 600.

In other words, since the sensing membrane 500 is formed in the gas inflow direction, the gas may be easily absorbed, whereby the gas sensor 10 may be easily protected only by the filter 600.

In addition, as shown in FIG. 12, the gas sensor 10 of the gas sensor package 1 is installed upside down on the circuit board 20, so that the opening direction of the multiple pores 123 on the substrate 100 is the same as the direction in which the lower surface of the circuit board 20 faces. In other words, the multiple pores 123 are open in a direction opposite to the direction in which the sensing target gas flows.

Therefore, even though the sensing target gas flows in, the gas does not flow into the pores 123, thereby preventing the substrate 100 from being contaminated by the gas.

Hereinafter, the effect of the gas sensor 10 according to the preferred embodiment of the present invention will be described.

In the case of the gas sensor in the related art, since the sensor electrode and the heater electrode are positioned on the same plane, and the sensing membrane is formed on the upper surface of the sensor electrode and the heater electrode, the heater electrode is not positioned in an area where the sensor electrode is positioned so that the area cannot be heated. Accordingly, there is a problem that the heat cannot be evenly transferred to the sensing membrane.

However, in the case of the gas sensor 10 according to the preferred embodiment of the present invention, the heating portion 310 of the heater electrode 300 is positioned above the sensing portion 210 of the sensor electrode 200. That is, the sensing portion 210 and the heating portion 310 are not positioned on the same plane, so that the heating portion 310 may evenly transfer the heat throughout the sensing portion 210.

Further, the insulating portion 410 of the passivation layer 400 is interposed between the sensing portion 210 of the sensor electrode 200 and the heating portion 310 of the heater electrode 300, so that the heat of the heating portion 310 is evenly transferred to the sensor electrode 200. Accordingly, the heat may be evenly transferred to the sensing membrane 500 formed on the lower surface of the sensing portion 210, so that the concentration of the gas may be accurately measured.

Air exists in the through-hole 110 so that thermal insulation effect is obtained, and the sensing membrane 500 is positioned inside the through-hole 110 so that the temperature loss is minimized when the sensing membrane 500 is heated.

Accordingly, the heating portion 310 of the heater electrode 300 can easily increase the temperature of the sensing membrane 500 by an appropriate temperature, even with low power consumption power, thereby making compact the gas sensor 10 and the gas sensor package 1.

In addition, since the temperature of the sensing membrane 500 may be easily maintained by the thermal insulation effect of the through hole 110 as described above, the concentration of the gas may be accurately measured.

Through structures of the first and second sensor electrode bridges 230a and 230b of the first and second sensor electrodes 200, the first to fourth supporting portions 421, 422, 423, and 424 of the passivation layer 400, and first and second heater electrode bridges 331 and 332 of the heater electrode 300, the sensing portion 210, the insulating portion 410, and the heating portion 310 may be positioned in such a manner as to cover at least a part of the through hole 110 above the through hole 110.

Therefore, the through hole 110 may be easily formed on the substrate 100, thereby achieving a thermal insulation effect of the gas sensor 10 described above.

While the present invention has been particularly shown and described with reference to exemplary embodiments thereof, it will be understood by those of ordinary skill in the art that various changes or modification may be made therein without departing from the spirit and scope of the invention as defined by the appended claims.

1. A gas sensor, comprising:
a substrate in which a through hole extending therethrough from an upper surface to a lower surface is formed;
a sensor electrode formed above the substrate and having a sensing portion covering at least a part of the through hole;
a heater electrode formed above the substrate and having a heating portion positioned above the sensing portion; and
a passivation layer having an insulating portion interposed between the sensing portion and the heating portion to insulate the sensing portion and the heating portion.

2. The sensor according to claim 1, wherein the sensor electrode includes a first sensor electrode having a first sensing portion and a second sensor electrode having a second sensing portion, in which the first sensing portion surrounds at least a part of the second sensing portion and the second sensing portion surrounds at least a part of the first sensing portion.

3. The sensor according to claim 1, further comprising a filter provided below the substrate and covering the through hole.

4. The sensor according to claim 1, wherein the substrate is made of anodized aluminum oxide (Al₂O₃), acquired by anodizing aluminum (Al) and then removing the aluminum (Al), and
multiple pores are formed in an upper surface of the substrate made of the anodized aluminum oxide.

5. The sensor according to claim 4, wherein the substrate made of anodized aluminum oxide includes:
a barrier layer; and
a porous layer positioned above the barrier layer and provided with the multiple pores.

6. The sensor according to claim 1, further comprising a sensing membrane formed below the sensing portion.

7. A gas sensor package having a circuit board and a gas sensor electrically connected to the circuit board, the gas sensor comprising:
a substrate in which a through hole extending therethrough from an upper surface to a lower surface is formed;
a sensor electrode formed above the substrate and having a sensing portion covering at least a part of the through hole;
a heater electrode formed above the substrate and having a heating portion positioned above the sensing portion;
a passivation layer having an insulating portion interposed between the sensing portion and the heating portion to insulate the sensing portion and the heating portion; and
a sensing membrane formed below the sensing portion,
in which the gas sensor is installed upside down on an upper surface of the circuit board so that a direction in which the sensing membrane, the sensor electrode, the passivation layer, and the heater electrode are laminated sequentially is the same as a direction in which a lower surface of the circuit board faces.

8. The package according to claim 7, wherein the substrate is made of anodized aluminum oxide, acquired by anodizing aluminum and then removing the aluminum,
the substrate made of anodized aluminum oxide includes:
a barrier layer; and
a porous layer positioned above the barrier layer and provided with multiple pores, and
a direction in which the multiple pores are open is the same as a direction in which a lower surface of the circuit board faces.
